(19) United States
(12) Patent Application Publication
(10) Pub. No.: US 2023/0010470 A1
(43) Pub. Date: Jan. 12, 2023

(54) APPARATUS FOR MANUFACTURING METAL POWDER

(71) Applicant: KOLON INDUSTRIES, INC., Seoul (KR)

(72) Inventors: Yong Hwan JI, Seoul (KR); Kyoung Hwa KIM, Seoul (KR); Mi So LIM, Seoul (KR); Shin KIM, Seoul (KR); Won Kyu SUH, Seoul (KR); Su Min KIM, Seoul (KR)

(21) Appl. No.: 17/783,295

(22) PCT Filed: Oct. 28, 2020
(86) PCT No.: PCT/KR2020/014825

§ 371 Date: Jun. 8, 2022

(30) Foreign Application Priority Data
Dec. 9, 2019 (KR) 10-2019-0162828

(51) Int. Cl. B22F 9/08

(52) U.S. Cl. CPC B22F 9/082; B22F 2009/0872; B22F 2009/088; B22F 2301/052; B22F 2301/205

(57) ABSTRACT

An apparatus for manufacturing metal powder according to the present invention is a metal powder manufacturing apparatus, in which molten metal is broken up, and liquid droplets of the atomized molten metal are cooled by spraying cooling water using a cooling water spraying nozzle provided inside a chamber. The cooling water spraying nozzle is provided such that cooling water is sprayed in a fan shape, and cooling water spraying nozzles provided at different heights have increasing angles of inclination with respect to the inner wall of the chamber as the heights thereof are reduced, thereby decreasing a deviation between flying distances of the molten metal liquid droplets to efficiently manufacture metal powder having uniform properties.

### TECHNICAL FIELD

The present disclosure relates to an apparatus for manufacturing metal powder.

### BACKGROUND ART

In a method of manufacturing metal powder, an atomizing process of spraying high-pressure gas or high-pressure water onto a molten metal is mainly used to break up the molten metal into small liquid droplets. Liquid droplets of a molten metal are cooled simultaneously while being atomized or through an additional cooling process while flight, to obtain a metal powder. The liquid droplets of the atomized molten metal droplets may form amorphous metal powder depending on a composition or a cooling rate of a metal.

Amorphous is a term referring to a state of a material having disordered and irregular atomic arrangement which does not form a crystal, and a typical example of an amorphous material is glass. Since amorphous metals do not have crystal orientation, they have high strength and excellent ductility. In addition, since amorphous metals have no magnetic anisotropy and low electrical resistance, they are used for various purposes. As a result, demand for amorphous metals has been increased in recent years.

To form a metal powder including such an amorphous metal, it may be important to cool a metal in a molten state at a high rate. This is because when the cooling rate of the metal in the molten state is insufficiently high, metal atoms in the molten metal are cooled to form a stable crystal, and thus, crystalline metal powder is formed.

Apparatuses for manufacturing metal powder according to the related art attempt to perform a cooling process using a coolant after atomizing a molten metal. However, the cooling rate is significantly low to manufacture amorphous metal powder, or even when a cooling rate is sufficient to obtain amorphous powder, sizes of particles are irregular and powder is manufactured to have a shape outside a spherical shape. In addition, a large amount of gas or cooling water is required to break up and cool a molten metal, resulting in increased manufacturing costs. Accordingly, there is a need to address the above issue.

### SUMMARY OF INVENTION

### Technical Problem

An aspect of the present disclosure is to provide an apparatus for manufacturing metal powder having high sphericity performance and a high amorphous formation rate, which is implemented by providing an appropriate flight distance and a cooling rate according to a falling path varying depending on sizes of scattered liquid droplets of a molten metal using an apparatus for cooling the liquid droplets of the molten metal, formed by atomization, with cooling water.

Another aspect of the present disclosure is to provide an apparatus for manufacturing metal powder, capable of manufacturing amorphous metal powder while reducing use of cooling water and maintenance costs by spraying the cooling water with a spraying nozzle.

### Solution to Problem

Example embodiments of the present disclosure provide an apparatus for manufacturing metal powder including a chamber in which a molten metal, broken up in a form of liquid droplets and then falling, is cooled.

The chamber includes a cooling water spraying nozzle disposed on an internal wall of the chamber to cool the broken-up molten metal.

The cooling water spraying nozzle includes a first cooling water spraying nozzle, forming a first angle of inclination θ₁₁ with the internal wall of the chamber in a vertical direction and provided at a first height, and a second cooling water spraying nozzle forming a second angle of inclination θ₁₂, greater than the first angle of inclination θ₁₁, in a vertical direction with respect to the internal wall of the chamber and provided at a second height, lower than the first height.

The first cooling water spraying nozzle may include a plurality of cooling water spraying nozzles disposed at the first height.

A relationship of θ₁₁<θ₁₂< . . . <θ₁ₙ may be satisfied, where among cooling water spraying nozzles each having a height lower than an (n-1) th height (n being a positive integer greater than 2), at least one cooling water spraying nozzle having a highest position is an n-th cooling spraying nozzle, and an angle between a spraying direction of the n-th cooling water spraying nozzle and the internal wall of the chamber in a vertical direction is an n-th angle θ₁ₙ.

The cooling water spraying nozzle may include a cooling water spraying nozzle spraying cooling water in a fan shape.

The apparatus may include a shielding plate provided on the internal wall of the chamber to protect the cooling water spraying nozzle.

In this case, an internal diameter in an upper portion of the chamber may be one to three times an internal diameter in a lower portion of the chamber.

A length of the chamber may be one to five times an internal diameter in an upper portion of the chamber.

A cooling water spray pressure of the cooling water spraying nozzle is 80 bar to 150 bar.

The first spraying angle may range from 30° to 90°, and the first angle of inclination may range from 10° to 60°

### Advantageous Effects of Invention

According to an aspect of the present disclosure, an apparatus for manufacturing metal powder may spray cooling water such that liquid droplets of a molten metal have an appropriate flight distance according to a falling path varying depending on a diameter of the liquid droplet of the molten metal, resulting in improved sphericity performance of the metal powder.

Cooling water may be sprayed from a spraying nozzle to remove a vapor film formed on a surface thereof while cooling liquid droplets of a metal, resulting in improved sphericity performance of metal powder.

In addition, the spraying nozzle may spray cooling water in the form of a flat fan, so that a contact area with liquid droplets of a metal is large and the cooling water is intensively sprayed, as compared with a case in which cooling water is sprayed in the form of a cone, resulting in improved cooling efficiency.

### BRIEF DESCRIPTION OF DRAWINGS

FIG. 1 is a schematic cross-sectional view illustrating a cross-section of an apparatus for manufacturing metal powder;

FIG. 2 is a schematic perspective view of the apparatus for manufacturing metal powder illustrated in FIG. 1; and

FIG. 3 is a plan view illustrating an internal wall of a chamber of an apparatus for manufacturing metal powder.

### BEST MODE FOR INVENTION

Prior to description of the present disclosure in detail below, it should be understood that the terms used herein are merely intended to describe specific embodiments and are not to be construed as limiting the scope of the present invention, which is defined by the appended claims. Unless otherwise defined, all terms including technical and scientific terms used herein have the same meaning as commonly understood by one of ordinary skill in the art to which this invention belongs.

Throughout this specification and the claims, unless otherwise defined, the terms “comprise,” “comprises,” and “comprising” will be understood to imply the inclusion of a stated object, a step or groups of objects, and steps, but not the exclusion of any other objects, steps or groups of objects or steps.

Meanwhile, unless otherwise noted, various embodiments of the present disclosure may be combined with any other embodiments. In particular, any feature which is mentioned preferably or favorably may be combined with any other features which may be mentioned preferably or favorably. Hereinafter, example embodiments and effects of the present disclosure will be described with reference to accompanying drawings.

In the present specification, a spraying nozzle refers to a jet port for jetting steam, liquid, gas, or the like, at high speed. When an expression “spraying nozzle” is used, it may be broadly interpreted as including a nozzle of a manner in which speed of a fluid is increased by reducing a cross-sectional area of a pipe, a jet port for spraying a fluid at high speed by applying a pressure to spray the fluid, and the like.

A molten metal supply container 10 may refer to a container containing a molten metal, and an orifice 11 may be provided on a bottom surface of the molten metal supply container 10 such that the molten metal is allowed to flow downwardly by gravity in a vertical direction. The molten metal is not limited in type and metal may include, for example, a high-activity metal such as titanium (Ti) and aluminum (Al). It is known that high-activity metals are readily oxidized by contacting air to form an oxide layer on a surface thereof, so that it may be difficult to refine the high-activity metals. However, the apparatus for manufacturing metal powder according to the present aspect is not limited in the type of metal.

In addition, a magnetic metal or an alloy and a molten metal having a composition for manufacturing the same, for example, metals having a composition for manufacturing iron-based amorphous alloy powder such as an Fe-Si-B-based amorphous metal, an Fe-Si-BP-based amorphous metal, an Fe-Si-B-Nb-Cu-based nanocrystalline metal, and Fe-Ni-M (metalloid) -T (other transition metal) may be used, and the molten metal may be cooled to form soft magnetic amorphous powder.

An orifice refers to the outlet through which the molten metal flows. The molten metal, maintained at a high temperature, flows from top to bottom inside a chamber through the orifice 11.

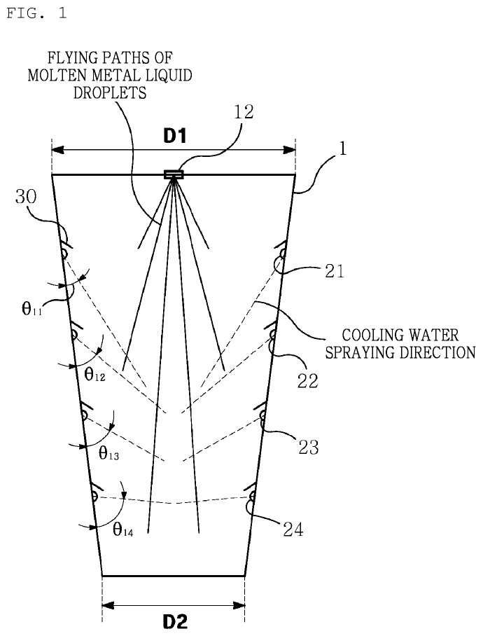

FIG. 1 is a schematic cross-sectional view illustrating a cross-section of an apparatus for manufacturing metal powder. The apparatus for manufacturing metal powder may include a fluid spraying nozzle, a chamber, and a cooling water spraying nozzle.

The fluid spraying nozzle 12 may be a spray port for spraying a fluid. The sprayed fluid is not limited, but may be preferably a gas. The gas may be a gas having no reactivity with a metal, and may be preferably a gas having low reactivity such as nitrogen or an inert gas such as argon.

The fluid spraying nozzle 12 may be provided in a periphery of the orifice 11 or below the orifice 11, and may be disposed to be directed to a straight line (a central axis) of a vertical direction in which the molten metal flows down from the orifice 11. Although an angle formed by the fluid spraying nozzle 12 with the central axis is not limited, the fluid spraying nozzle 12 may be preferably disposed to spray a gas in a direction of gravity while forming an acute angle with the central axis.

In the case in which the fluid spraying nozzle 12 is perpendicular to the central axis, spray gases sprayed from different nozzles may collide with each other and a direction, in which liquid droplets of the molten metal are scattered, is not constant. Thus, quality of the metal powder is not good. In particular, there is a possibility that the liquid droplets of the molten metal are scattered toward the orifice 11 to clog or narrow the orifice 11. Therefore, the above-described case is not preferable.

The fluid spraying nozzle 12 may be provided as a plurality of fluid spraying nozzles annularly arranged around the orifice 11. The plurality of fluid spraying nozzles may be configured to spray gas toward a specific point disposed in a vertical direction in the orifice 11. In this case, a liquid of the metal molten flowing down may be scattered into fine droplets of the molten metal by the sprayed gas and may fall into the chamber while forming a cone shape.

The chamber is a chamber in which particles of the molten metal are cooled, and is preferably provided as a cylindrical body having a space therein. The chamber 1 maybe disposed below the molten metal supply container. A shape of the chamber 1 is not limited, but the chamber 1 may preferably have a cylindrical shape, and an internal diameter of the chamber 1 may be large in an upper portion and may be reduced in a direction toward a lower portion. D1/D2, a ratio of an internal diameter D1 in the upper portion of the chamber 1 to an internal diameter D2 in the lower portion of the chamber 1, may be 1 or more to 3 or less, and may be preferably 1.2 to 2.5.

A central axis of the chamber 1 maybe installed to match the orifice 11 of the molten metal supply container, and the orifice 11 may not match the central axis of the chamber 1 depending on an angle and arrangement of the cooling water spraying nozzles. The central axis of the chamber 1 may not be parallel to a vertical direction, and may be obliquely provided to form a constant angle with the vertical direction.

A length of the chamber 1 may be within the range of 1 to 5 times, preferably 1.5 to 4 times, the internal diameter of the upper portion of the chamber 1 such that a distance, at which the molten metal flowing down is scattered, is secured to improve the sphericity performance.

When a length-to-diameter ratio of the chamber 1 is outside a corresponding range, an installation height interval of the cooling water spraying nozzles 20 may be increased. In addition, a range, in which a scattering distance of the liquid droplets of the molten metal droplets may be adjusted by adjusting an angle of the cooling water spraying nozzle, may be narrowed or a distance between the molten metal and the cooling water spraying nozzle may be increased. Accordingly, the liquid droplets of the molten metal may be cooled before being spherized, so that cooling efficiency may be deteriorated.

When a ratio of the diameters of the upper and the lower portion to the length of the chamber is within a corresponding range, cooling using cooling water may be intensively performed in the lower portion of the chamber to increase cooling efficiency of the molten metal.

The cooling water spraying nozzle may be a nozzle disposed on an internal surface of the chamber 1 to spray cooling water cooling the molten metal that has been turned into liquid droplets. As the cooling water spraying nozzle, a spraying nozzle may be used to spray cooling water at high speed.

Among the cooling water spraying nozzles provided on the internal wall of the chamber, a cooling water spraying nozzle disposed in an uppermost portion will be referred to as a first cooling water spraying nozzle 21, and a height at which the first cooling water spraying nozzle 21 is disposed will be defined as a first height. The first cooling water spraying nozzle 21 may be a single cooling water spraying nozzle, and may include a plurality of cooling water spraying nozzles having the same first height.

Among cooling water spraying nozzles disposed at a height lower than the first height, a cooling water spraying nozzle having a highest position will be referred to as a second cooling water spraying nozzle 22, and a height at which the second cooling water spraying nozzle 22 is disposed will be defined as a second height. The second cooling water spraying nozzle 22 may be a single cooling water spraying nozzle, and may include a plurality of cooling water spraying nozzles having the same second height. Similarly, a third height, a fourth height, a third cooling water spraying nozzle 23, and a fourth cooling water spraying nozzle 24 may be defined. Among the cooling water spraying nozzles disposed at a height lower than an (n-1)th height, a cooling water spraying nozzle having a highest position will be referred to as an n-th cooling water spraying nozzle, and a height at which the n-th cooling water spraying nozzle is disposed will be defined as an n-th height.

An angle of inclination may be interpreted as referring to an angle formed by a direction, in which cooling water of a cooling water spraying nozzle is sprayed, with an internal wall of the chamber in a vertical direction, and may be interpreted as an angle formed by a contact plane, contacting the internal wall of the chamber, and a virtual straight line on a point at which the virtual straight line in a spraying direction meets the internal wall of the chamber.

An angle of inclination of the first cooling water spraying nozzle 21 will be referred to as a first angle of inclination, and an angle of inclination of the second cooling water spraying nozzle 22 will be referred to as a second angle of inclination. Similarly, an angle of inclination of the third cooling water spraying nozzle 23 will be referred to as a third angle of inclination angle, an angle of inclination of the fourth cooling water spraying nozzle 24 will be referred to as a fourth angle of inclination, and an angle of the n-th cooling water spraying nozzle will be referred to as an n-th angle of inclination.

When a plurality of first cooling water spraying nozzles 21 disposed at the first height are provided, all of the plurality of cooling water spraying nozzles may have the same first angle of inclination or two or more first angles of inclination. The disposition of the cooling water spraying nozzles 20 is not limited, but the cooling water spraying nozzles 20 is preferably disposed, such that they are rotationally symmetric about the central axis or a distance between the respective cooling spraying nozzles 20 is significantly increased, to uniformly cool the metal powder.

For example, the two cooling water spraying nozzles 20 maybe disposed to oppose each other with respect to the central axis, and the three cooling water spraying nozzles 20 may be disposed in the form of an equilateral triangle while forming an angle of 120 degrees with respect to the central axis. An example embodiment provides a structure in which the cooling water spraying nozzles 20 are disposed to be symmetric with respect to the central axis.

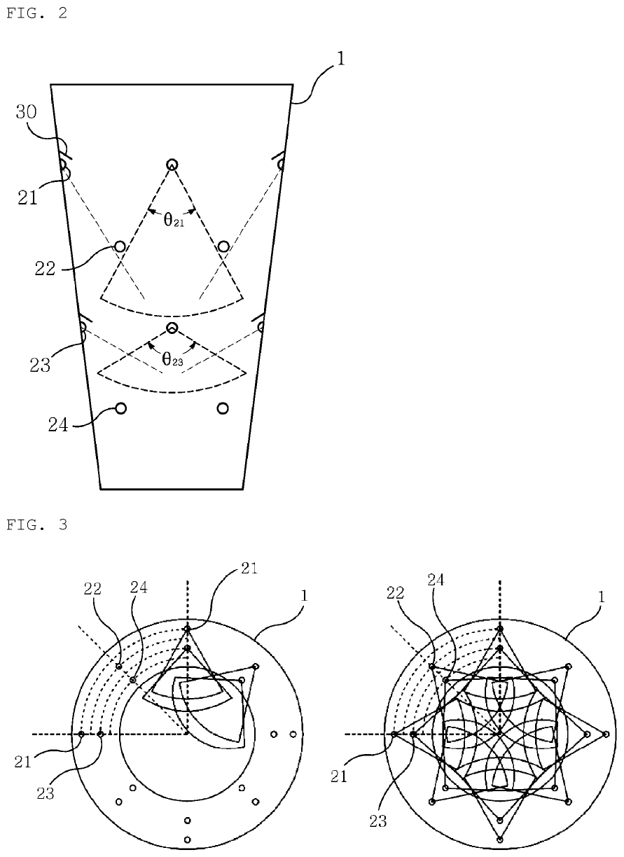

The cooling water spraying nozzles having different heights may be alternately disposed, as illustrated in FIG. 2. In the example embodiment illustrated in FIG. 2, the first cooling water spraying nozzle 21 and the second cooling water spraying nozzle 22 are alternately disposed, and the second cooling water spraying nozzle 22 and the third cooling water spraying nozzle 23 are alternately disposed.

### Mode for Invention

The cooling water spraying nozzle 20 may spray cooling water toward the central axis of the chamber 1, and a spraying direction of a nozzle may have an angle of inclination. The angle of inclination may be increased as a height of a cooling water spraying nozzle is decreased. The first angle of inclination may be formed to be 10° or more to 60° or less, preferably in a range of 10° to 30°. Then, the second inclination angle may be formed to be greater than or equal to the first angle of inclination, and a difference from the first angle of inclination may be 0° or more to 30° or less, and preferably ranges from 5° to 15°.

The third angle of inclination may be greater than or equal to the second angle of inclination, and a difference from the second angle of inclination may be 0° or more to 30° or less, and preferably ranges from 5° to 15°.

When a first angle of inclination formed by the first cooling water spraying nozzle 21 with the internal wall of the chamber 1 is θ₁₁ and an n-th angle of inclination of the n-th cooling water spraying nozzle is θ₁ₙ, a relationship of θ₁₁ θ₁₂ . . . ≤θ₁ₙ may be established with respect to n greater than 2, and a relationship of θ₁₁<θ₁₂< . . . <θ₁ₙ may be preferably established. The n-th angle of inclination may be greater than or equal to the (n-1)th angle of inclination, and a difference from the (n-1)th angle of inclination may be 0° or more to 30° or less, and preferably ranges from 5° to 15°.

The cooling water spraying nozzle 20 may spray cooling water with an angle of inclination to provide a flight distance varying depending on a diameter of a metal liquid droplet scattered by the fluid spraying nozzle 12. Since the scattered molten metal liquid droplet has mass increased as a diameter thereof is increased, it may have high kinetic energy and may receive less resistance of liquid to have a flight path close to a direction of gravity. In addition, since a liquid droplet having a small diameter has small mass, it may have low kinetic energy and may receive resistance of sprayed liquid to have a flight path spreading with a large spraying angle.

A flight distance of a large-diameter liquid droplet may vary. When the cooling water is sprayed in a horizontal direction, the flight distance of the large-diameter liquid droplet maybe decreased. Meanwhile, when the cooling water is formed only on an internal wall of the chamber 1, the flight distance of the large-diameter liquid droplet maybe increased. When the cooling water is sprayed at a predetermined angle with respect to the internal wall of the chamber 1 toward the central axis, the flight distances of large-diameter droplets and small-diameter droplets may be adjusted.

When a flight distance is significantly short, sphericity performance may be poor because particle spherization using surface tension may not be performed well, and when the flight distance is significantly long, a cooling rate may be low, so that an amorphous material may not be performed. Therefore, it is necessary to adjust a flight distance at which an amorphous material is formed and sphericity performance is improved, so that an angle and an installation position of the cooling water supply nozzle 20 may be adjusted to efficiently manufacture metal powder.

An arrangement, in which an angle of inclination is increased as a height is decreased, may have an effect of reducing an interval between cooling water stages, sprayed from a cooling water spraying nozzle, in a direction toward the central axis of the chamber 1. As a diameter of a metal liquid droplet is increased, a flight path of the metal liquid droplet maybe closer to the central axis. Therefore, the metal liquid droplet may have a high cooling rate while passing through a plurality of cooling water layers at high speed, and thus, cooling efficiency may be improved.

The angle of inclination of the cooling water spraying nozzle 20 may be adjusted. When powder having different properties is manufactured from a molten metal having a single composition or when a composition of a molten metal is changed, to manufacture particles having the same or better properties, a spraying angle of the cooling water may be adjusted to adjust a scattering distance and a cooling rate of a molten metal liquid droplet and to manufacture powder having a higher amorphous ratio or improved sphericity performance. Adjustment of the angle of inclination may be within a range of 30 degrees in a vertical direction.

FIG. 2 is a schematic perspective view of the apparatus for manufacturing metal powder illustrated in FIG. 1. A cooling water spray type of a cooling water spraying nozzle 20, installed on an internal wall of a chamber, is represented by broken lines. The cooling water spray type of the cooling water spraying nozzle 20 and a spraying angle of cooling water injected from the cooling water spraying nozzle 20 may vary depending on a height of the cooling water spraying nozzle 20.

The cooling water sprayed from the spraying nozzle is sprayed in the form of a flat fan, and a central angle of the fan is defined as a spraying angle. The spraying angle may range from 30° to 130°, preferably from 35° to 110°, more preferably from 40° to 90°.

The cooling water is intensively sprayed in the fan-shaped spraying of the cooling water spraying nozzle 20 as compared with cone-shaped spraying, so that the cooling water maybe sprayed at a high density to increase cooling efficiency and to easily remove a vapor layer on a surface of metal powder particles. In addition, the cooling water may be sprayed in the form of a fan and a contact area may be large, so that the cooling water may contact and cool even molten metal liquid droplets falling away from the central axis of the chamber.

When the first cooling water spraying nozzle 21 includes a plurality of cooling water spraying nozzles 20, the first cooling water spraying nozzle 21 may be provided to have the same spraying angle and to allow the spraying angle to vary depending on a height of the spraying nozzle.

In the example embodiment illustrated in FIG. 2, the spraying angle may be increased as the height of the cooling water spraying nozzle 20 is decreased. When a spraying angle of a first cooling water spraying nozzle 21 is 021 and an injection angle of an n-th cooling water spraying nozzle is θ2n, a relationship of θ21≤θ22≤ . . . ≤θ2n or θ21<θ22< . . . <θ2n may be established.

In the configuration in which the spraying angle of the cooling water spraying nozzle 20 is increased as the height is decreased, cooling of the metal liquid droplets may be increased in a direction toward a lower end of the chamber 1, so that intensive spray cooling efficiency of the cooling water for a single metal liquid droplet may be decreased. Therefore, a contact area may be significantly reduced, so that the cooling water may contact a large number of metal liquid droplets to improve an overall cooling effect.

FIG. 3 is a plan view illustrating an internal wall of a chamber of an apparatus for manufacturing metal powder. A first cooling water spraying nozzles 21 to a fourth cooling water spraying nozzles 24 may include four cooling water spraying nozzles at respective heights, and may be disposed to be spaced apart from each other by 90 degrees. The second cooling water spraying nozzle 22 may be disposed to rotate by 45 degrees about the first cooling water spraying nozzle 21, and the first and second cooling water spraying nozzles 21 and 22 may be alternately disposed. The third cooling water spraying nozzle 23 may have the same disposition as the first cooling water spraying nozzle 21 at a third height, and the fourth cooling water spraying nozzle 24 may have the same disposition as the second cooling water spraying nozzle 22 at a fourth height. A cooling water stage, formed by such an intersecting nozzle disposition, may allow an efficient cooling water stage having a large contact area to be formed.

A spraying type of the cooling water spraying nozzle may be in the form of a flat fan, and the cooling water spraying nozzle may include a conic spraying nozzle. Some of the plurality of cooling water spraying nozzles may spray cooling water in the form of a flat fan, and some of the plurality of cooling water spraying nozzles may spray cooling water in the form of a cone. In addition, various cooling water spraying manners may be used.

As the cooling water sprayed from the cooling water spraying nozzle 20 is sprayed at higher pressure and higher, the molten metal liquid droplets may be broken up or a vapor layer on a surface of the molten metal droplet formed by contacting the cooling water with the molten metal droplet may be broken up. Thus, heat exchange efficiency may be improved to increase a cooling rate and an amorphous degree of the metal powder. The pressure of the cooling water may be 80 bar to 150 bar, preferably 90 bar to 130 bar, and the spraying rate of the cooling water is not limited and may include a spraying rate, which may be obtained by the configuration of the nozzle, within a pressure range of the corresponding cooling water.

The apparatus for manufacturing metal powder may further include an angle adjusting means, capable of adjusting an angle of the cooling water spraying nozzle. The angle adjusting means may connect the cooling water spraying nozzle to the internal wall of the chamber, and may adjust a spraying direction of the cooling water spraying nozzle. Since the angle of the cooling water spraying nozzle may be adjusted, a scattering distance may be adjusted to be longer in a molten metal of the same composition, so that a particle shape of the metal powder may be adjusted to be closer to a spherical shape. In addition, an amorphous ratio of metal powder, manufactured by increasing a cooling speed of a dropletized metal while setting a scattering distance to be relatively short, may be adjusted to be high. Such a spraying angle may be adjusted depending on a composition of a molten metal and detailed properties of metal powder to be manufactured, so that metal powder having various characteristics may be manufactured in the same apparatus.

In addition, when the composition of the molten metal varies, an amorphous ratio depending on cooling of the particles and a degree of sphericity depending on surface tension may vary even at the same cooling water spraying nozzle angle, and the cooling water spraying nozzle may be adjusted to manufacture metal powder at a scattering distance and a cooling speed optimized for the metal composition.

Even when the composition of the molten metal does not vary and target properties varies, adjustment of the angle of the cooling water spraying nozzle may cause sphericity performance to be improved or may cause a particle size of powder to be uniform, without new equipment or investment.

Liquid droplets of the molten metal are spattered to a nozzle to cool the cooling water spraying nozzle 20 and a spray port of the nozzle may be clogged or narrowed to interfere with spraying of the spraying nozzle 20, or cooling water may flow down along an internal surface of a chamber to interfere with spraying of the cooling water spraying nozzle. To prevent such a case, the chamber 1 may include a shielding plate 30, covering the cooling water spraying nozzle 20 and provided on the internal wall, to protect the cooling water spraying nozzle 20.

A structure of the shielding plate 30 is not limited as long as it is installed on the upper portion of the cooling water spraying nozzle 20 to serve to cover or surround the cooling water spraying nozzle 20 from scattered metal liquid droplets without blocking a spraying path of the cooling water spraying nozzle 20. The shielding plate 30 may be in the form of a flat plate or in the form of a folded flat plate, and may have a curved surface or only an open portion surrounding a portion of a spherical surface or both an upper portion and a lower portion of the cooling water spraying nozzle and corresponding to the spraying path.

Metal powder formed in a lower portion of the chamber may be transferred together with cooling water to be subjected to a drying process, and used cooling water may be separated from the powder to be processed and may then be resupplied to the cooling water supply nozzle 20 through a pump to be reused.

Features, structures, effects, etc. exemplified in each of the above-described embodiments may be combined or modified for other embodiments by those of ordinary skill in the art to which the embodiments belong. Accordingly, the contents related to such combinations and modifications should be interpreted as being included in the scope of the present disclosure.

### DESCRIPTION OF REFERENCE CHARACTERS

1: chamber 10: molten metal supply container

11: orifice 12: fluid spraying nozzle

20: cooling water spraying nozzle 21: first cooling water spraying nozzle

22: second cooling water spraying nozzle 23: third cooling water spraying nozzle

24: fourth cooling water spraying nozzle 30: shielding plate.

1. An apparatus for manufacturing metal powder comprising a chamber in which a molten metal, broken up in a form of liquid droplets and then falling, is cooled,
wherein the chamber comprises a cooling water spraying nozzle disposed on an internal wall of the chamber to cool the broken-up molten metal, and
wherein the cooling water spraying nozzle comprises a first cooling water spraying nozzle, forming a first angle of inclination θ₁₁ with the internal wall of the chamber in a vertical direction and provided at a first height, and a second cooling water spraying nozzle forming a second angle of inclination θ₁₂, greater than the first angle of inclination θ₁₁, in a vertical direction with respect to the internal wall of the chamber and provided at a second height, lower than the first height.

2. The apparatus of claim 1, wherein the first cooling water spraying nozzle comprises a plurality of cooling water spraying nozzles disposed at the first height.

3. The apparatus of claim 2, wherein θ₁₁<θ₁₂< . . . <θ₁ₙ,
where among cooling water spraying nozzles each having a height lower than an (n-1) th height (n being a positive integer greater than 2), at least one cooling water spraying nozzle having a highest position is an n-th cooling spraying nozzle, and an angle between a spraying direction of the n-th cooling water spraying nozzle and the internal wall of the chamber in a vertical direction is an n-th angle θ₁ₙ.

4. The apparatus of claim 1, wherein the cooling water spraying nozzle comprises a cooling water spraying nozzle spraying cooling water in a fan shape.

5. The apparatus of claim 1, comprising a shielding plate provided on the internal wall of the chamber to protect the cooling water spraying nozzle.

6. The apparatus of claim 1, wherein an internal diameter in an upper portion of the chamber is one to three times an internal diameter in a lower portion of the chamber.

7. The apparatus of claim 1, wherein a length of the chamber is one to five times an internal diameter in an upper portion of the chamber.

8. The apparatus of claim 1, wherein a cooling water spray pressure of the cooling water spraying nozzle is 80 bar to 150 bar.

9. The apparatus of claim 1, wherein the first angle of inclination is 10° to 60°.

10. The apparatus of claim 4, wherein a spraying angle, a fan-shaped central angle at which the cooling water spraying nozzle sprays cooling water, ranges from 30° to 130°.
